(19) United States
(12) Patent Application Publication
(10) Pub. No.: US 2006/0174298 A1
(43) Pub. Date: Aug. 3, 2006

(54) APPARATUS AND RELATED METHOD FOR SHARING ADDRESS AND DATA PINS OF A CRYPTOCARD MODULE AND EXTERNAL MEMORY

(76) Inventors: Wei-Jen Chen, Taipei Hsien (TW); You-Min Yeh, Chi-Lung City (TW)

Correspondence Address: NORTH AMERICA INTELLECTUAL PROPERTY CORPORATION, P.O. BOX 506, MERRIFIELD, VA, 22116, US

(21) Appl. No.: 10/906,006

(22) Filed: Jan. 31, 2005

(51) Int. Cl. H04N 7/16; H04N 7/173

(52) U.S. Cl. 725/100; 725/131; 725/151; 725/139

(57) ABSTRACT

A digital television (DTV) system has a front-end circuit comprising a DTV demodulator and a back-end circuit. The back-end circuit includes a DTV demultiplexer, a cryptocard module controller, and an external memory controller. The DTV system also includes an external memory coupled to the back-end circuit, an address bus and a data bus to which the external memory is coupled through a plurality of address and data pins, and a cryptocard module coupled to the front-end circuit and the back-end circuit for performing conditional access and security functions, the cryptocard module having address and data pins coupled to address and data pins of the external memory.

### BACKGROUND

The invention relates to an information receiver, and more specifically, to a digital television (DTV) system with address and data pins of a cryptocard module coupled with address and data pins of an external memory for reducing the number of pins used.

In digital cable systems, video/audio content is protected by a conditional access scrambling system. A cryptocard module, such as an Advanced Televisions Systems Committee (ATSC) Point of Deployment (POD) security module (now called CableCARD) or a Digital Video Broadcasting Common Interface (DVB-CI) module, removes the scrambling and may rescramble the video content before delivering it to consumer receivers and set-top terminals (known as host devices) across an interface between the cryptocard module and the host device. The cryptocard security module has a CPU interface to communicate with the CPU of the host device. In addition, host devices often connect to peripherals or to external memories, such as a ROM or flash memory, for CPU instruction or data storage.

Please refer to FIG. 1. FIG. 1 is a block diagram of a conventional DTV system 10. The DTV system 10 comprises a host front-end IC 20, a host back-end IC 30, and a POD module 50. The host front-end IC 20 is connected to a cable connection for processing the video/audio content provided by the cable connection. The host front-end IC 20 comprises a transmit circuit 24 and a receive circuit 26 for communicating with an out-of-band port of the POD module 50. The video/audio content is also received by a tuner circuit 22 and passed to a demodulator circuit 28. The demodulator circuit 28 removes a carrier frequency of the video signal and transmits the result directly to a demultiplexer 32 of the host back-end IC 30 through a first transport stream port TS1 and to an inband port of the POD module 50. The POD module 50 descrambles video signals and provides the descrambled video stream to the demultiplexer 32 through a second transport stream port TS2.

The host back-end IC 30 contains a POD CPU interface 34 for communicating address and data information with the POD module 50 through a CPU interface of the POD module 50. An external memory interface 36 of the host back-end IC 30 is used for communicating with external memory and peripheral devices through an address and data bus 45. The external memory is used for storing instructions or data for the host back-end IC 30. As shown in FIG.1, the external memory interface 36 communicates with a flash memory 40, a read-only memory (ROM) 42, and peripheral devices 44.

Unfortunately, the great number of connections between devices in the DTV system 10 requires a high number of pins to be used for connecting the devices. For example, even though the POD CPU interface 34 may not interface with the POD module 50 frequently and the external memory interface 36 also may not access the external memory 40, 42 and peripherals 44 frequently, each of these connections still uses its own set of address and data pins in the DTV system 10. Moreover, the demultiplexer 32 uses at least two transport stream ports TS1 and TS2 for receiving transport stream data. Each of these transport stream ports TS1 and TS2 requires multiple pins to be used, and also increases the overall use of pins on the host back-end IC 30. Using a large number of pins increases the cost of manufacturing the host back-end IC 30, increases the footprint of the host back-end IC 30, and makes designing the host back-end IC 30 more difficult.

### SUMMARY

A digital television system and pin sharing method are provided. An exemplary embodiment of a DTV system is disclosed. The DTV system comprises a front-end circuit and a back-end circuit. The DTV system also comprises an external memory coupled to the back-end circuit; an address bus and a data bus to which the external memory is coupled through a plurality of address and data pins; and a cryptocard module coupled to the front-end circuit and the back-end circuit for performing conditional access and security functions, the cryptocard module having address and data pins coupled to address and data pins of the external memory.

An exemplary embodiment of an information receiver is disclosed. The information receiver comprises a host circuit, an external memory coupled to the host circuit, and an address bus and a data bus to which the external memory is coupled through a plurality of address and data pins. The information receiver also comprises a cryptocard module coupled to the host circuit for performing conditional access and security functions, the cryptocard module having address and data pins coupled to address and data pins of the external memory.

An exemplary embodiment of a method for sharing pins between a cryptocard module and external memory in a DTV system is disclosed. The DTV system comprises a host circuit comprising a cryptocard module controller and an external memory controller. The DTV system also includes an external memory coupled to the host circuit; an address bus and a data bus to which the external memory is coupled through a plurality of address and data pins; and a cryptocard module coupled to the host circuit for performing conditional access and security functions. The method comprises coupling address and data pins of the cryptocard module to address and data pins of the external memory; and switching the address and data pins of the cryptocard module between a first mode and a second mode.

### BRIEF DESCRIPTION OF DRAWINGS

FIG. 1 is a block diagram of a conventional DTV system.

FIG. 2 to FIG. 5 are functional block diagrams of DTV systems according to first through fourth exemplary embodiments.

### DETAILED DESCRIPTION

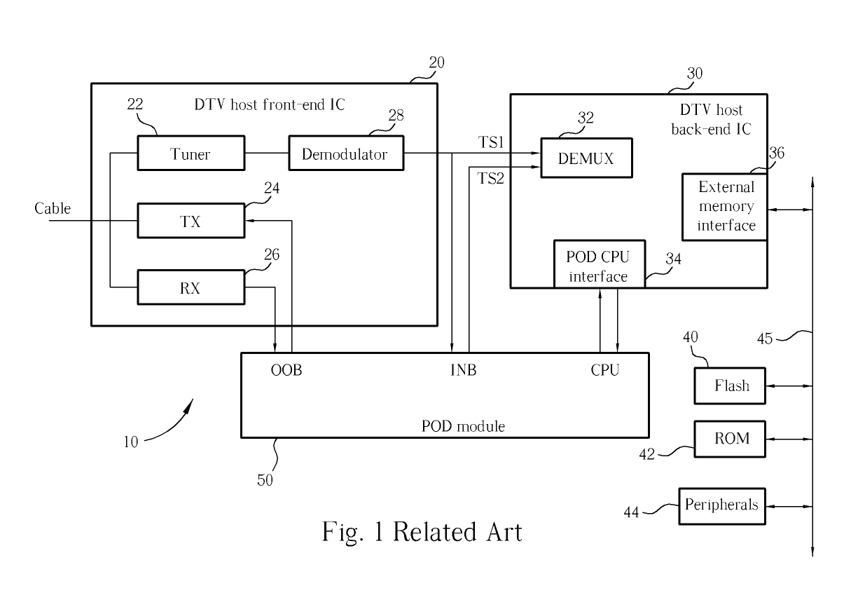

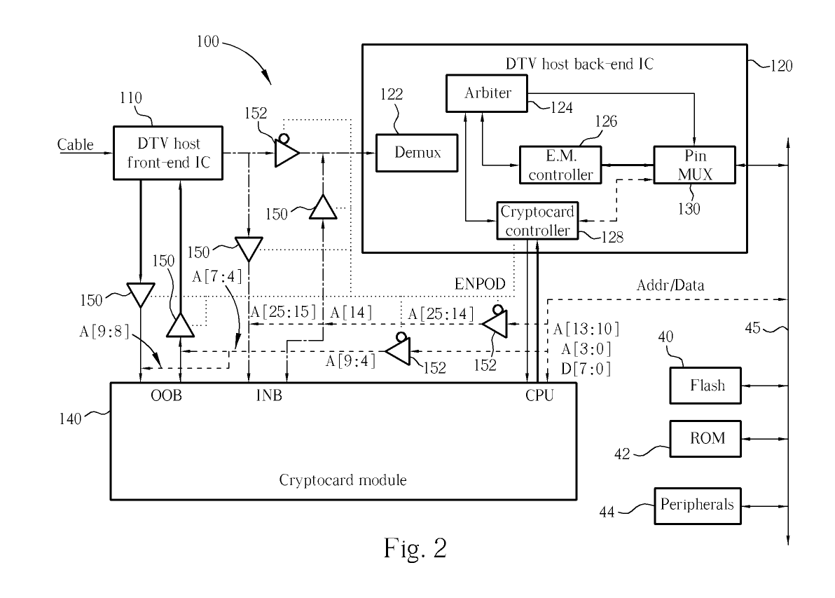

Please refer to FIG. 2. FIG. 2 is a functional block diagram of an exemplary embodiment of an information receiver such as DTV system 100. As in the DTV system 10 shown in FIG. 1, the DTV system 100 contains a host front-end IC 110, a host back-end IC 120, and a cryptocard module 140. The host front-end IC 110 can be the same or similar to the host front-end IC 20 of FIG. 1, and contains at least a demodulator circuit for removing a carrier frequency of the video signal received from a cable connection.

The cryptocard module 140 contains a CPU interface for communicating with the host back-end IC 120. The CPU interface of the cryptocard module 140 transmits data signals, address signals, and control signals. Since the host back-end IC 120 may only infrequently access the cryptocard module 140, the external memories 40, 42 and the peripherals 44, it is possible to share the address and data buses among the cryptocard module 140, the external memories 40, 42 and the peripherals 44.

Like the host back-end IC 30 shown FIG. 1, the host back-end IC 120 also contains a demultiplexer 122 which demultiplexes audio/video data and decodes transport stream layer information from the host front-end IC 110 and the cryptocard module 140. Unlike the host back-end IC 30, however, the host back-end IC 120 contains a cryptocard controller 128, an external memory controller 126, a pin multiplexer 130, and an arbiter 124. The cryptocard controller 128 controls access to the cryptocard module 140 and the external memory controller 126 controls access to the memories 40, 42 and the peripherals 44. When the cryptocard controller 128 or the external memory controller 126 wants to access the address and data bus 45, they request access from the arbiter 124. The arbiter 124 then determines which of the cryptocard controller 128 and the external memory controller 126 has the right to access the address and data bus 45, and controls the pin multiplexer 130 to select address or data from either the cryptocard controller 128 or the external memory controller 126.

The cryptocard module 140 can be utilized in either a first (POD) mode or in a second (PCMCIA) mode. Initially, the cryptocard module 140 will be in PCMCIA mode for allowing the host back-end IC 120 to access the cryptocard module 140, the external memories 40, 42 and peripherals 44 through the shared address and data pins by means of pin arbitration. After the host back-end IC 120 sets cryptocard module 140 to be in POD mode, some of the PCMCIA address pins, such as A4-A9 and A14-A25 are used to carry transport stream data, conditional access messages, or network management messages of the DTV system 100. In order for the same address pins to be utilized in both POD mode and in PCMCIA mode, tri-state buffers 150, 152 are added to the DTV system 100, and a control signal ENPOD is used for controlling these tri-states buffers. When the control signal ENPOD has a value of logical “1”, the active-high tri-state buffers 150 are in an enabled state and the active-low tri-state buffers 152 are in a high-impedance state, and vice versa.

When the cryptocard module 140 is in PCMCIA mode, the control signal ENPOD has a value of logical “0”, and the address pins A0-A25 and the data pins D0-D7 of the address and data bus 45 can be shared with the external memories 40, 42 and the peripherals 44. When the cryptocard module 140 is in POD mode, the control signal ENPOD has a value of logical “1”, and some of the address pins, A4-A9 and A14-A25, are separated from the external memory address bus. In FIG. 2-FIG. 5, the dashed lines such as the line connecting the address and data bus 45 and the CPU port of the cryptocard module 140 indicate signal paths used when the cryptocard module 140 is in PCMCIA mode; the dotted and dashed lines such as the line connecting the host front-end IC 110 and the inband port of the cryptocard module 140 indicate signal paths used when the cryptocard module 140 is in POD mode; and the dotted lines indicate the path of the control signal ENPOD.

As shown in FIG. 2, the demultiplexer 122 requires one transport stream input port in the DTV system 100. This compares with two transport stream ports TS1 and TS2 used in the conventional DTV system 10. When the cryptocard module 140 is in PCMCIA mode, the demultiplexer 122 receives the transport stream from the demodulator of the host front-end IC 110 directly. When the cryptocard module 140 is in POD mode, the demultiplexer 122 receives the transport stream from the cryptocard module 140. The tri-state buffers 150, 152 are used to control the flow of the transport stream. Please note that the tri-state buffers 150, 152 can also be replaced with switches, multiplexers, or other similar controllable devices.

The DTV system 100 shown in FIG. 2 is an example of a system conforming to the Advanced Televisions Systems Committee (ATSC) standards. Please note, that the DTV system 100 can also be adapted for the Digital Video Broadcasting standards. Therefore, the cryptocard module 140 is either an ATSC compliant POD/CableCARD module or a DVB compliant Common Interface module, for performing conditional access and security functions that allow selective access to digital cable services.

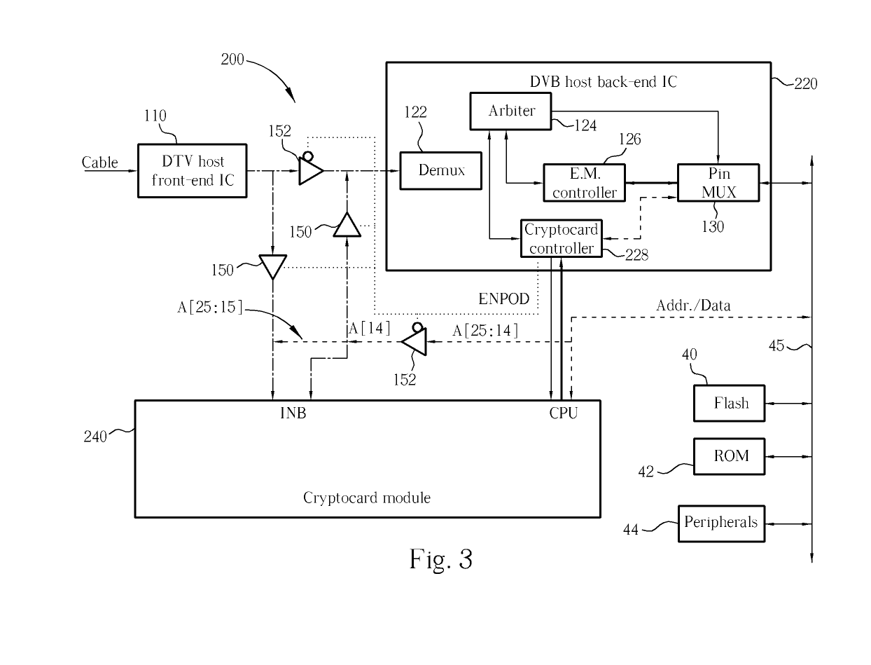

Please refer to FIG. 3. FIG. 3 is a functional block diagram of an exemplary embodiment of an information receiver such as DTV system 200. Differing from the DTV system 100 shown in FIG. 2, the DTV system 200 contains a host back-end IC 220 and a cryptocard module 240 of DVB-CI type. The host back-end IC 220 contains a cryptocard controller 228 for Common Interface instead of the cryptocard controller 128 used in the host back-end IC 120 shown in FIG. 2. One main difference between the cryptocard module 240 and the cryptocard module 140 is that the cryptocard module 240 does not have an out-of-band port. Tri-state buffers 150, 152 are used for controlling the flow of the transport stream.

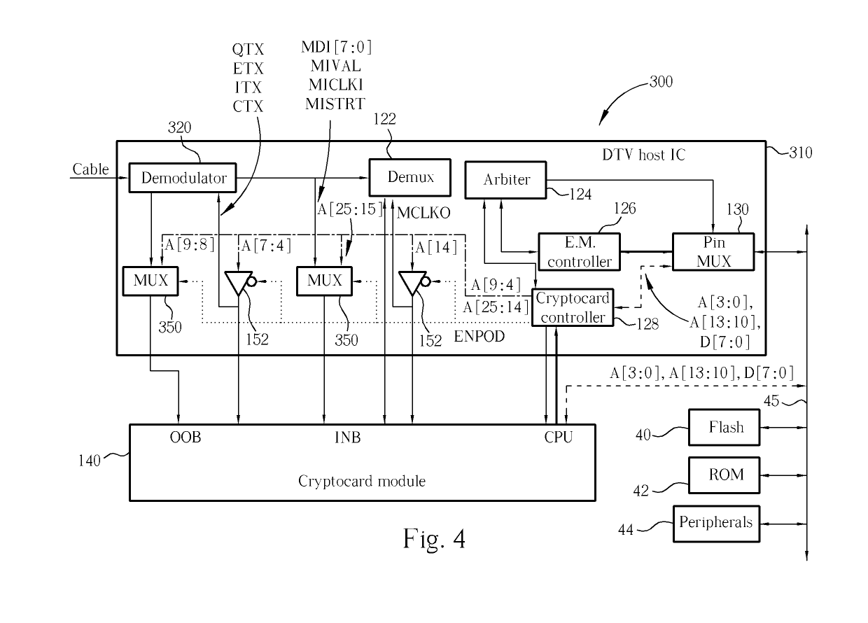

Please refer to FIG. 4. FIG. 4 is a functional block diagram of an exemplary embodiment of an information receiver such as DTV system 300. The DTV system 300 is a single chip solution having a host IC 310 in the form of a single IC instead of using separate front-end and back-end ICs. For optimizing the number of pins that are required, the cryptocard controller 128 shares address pins A0-A3 and A10-A13 and data pins D0-D7 with the external memories 40, 42 and peripherals 44. The cryptocard controller 128 shares pins of address signals A15-25 with the signals MDIO-7, MIVAL, MICLKI, MISTRT to be sent from a demodulator 320 of the host IC 310 to the inband port of the cryptocard module 140. The control signal ENPOD controls a multiplexer 350 to select the appropriate set of signals. Similarly, pins used for address signals A8-A9 are shared with out-of-band signals DRX and CRX and selected by the use of another multiplexer 350. The control signal ENPOD also controls the flow of address signals A14 and A4-A7 along with inband signal MCLKO and out-of-band signals QTX, ETX, ITX, CTX through the use of tri-state buffers 152.

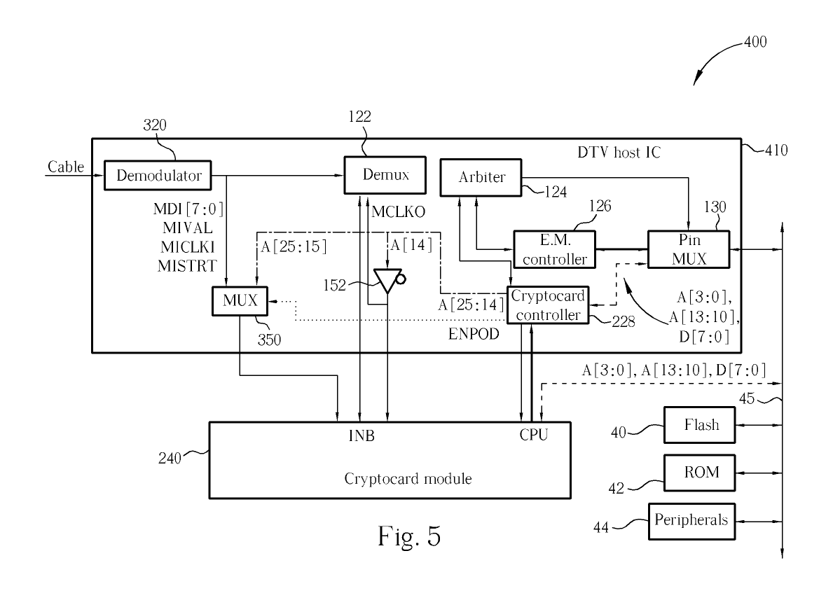

Please refer to FIG. 5. FIG. 5 is a functional block diagram of an exemplary embodiment of an information receiver such as DTV system 400. The DTV system 400 contains a single chip host IC 410 for use with a cryptocard module 240 of DVB-CI type. The DTV system 400 is similar to the DTV system 300 without the out-of-band related signals.

In contrast to the conventional DTV system, the four embodiments described above address and data pins of the cryptocard module are coupled to address and data pins of the external memory for reducing the total number of pins used on the back-end circuit. For example, sharing data pins enables 8 or 16 pins to be saved, depending on the types of circuits used. In addition, up to 26 address pins (A0-A25) can be shared as well. Moreover, by reducing the number of transport stream ports from two to one, an additional number of pins (for example, 11 pins can be used for each transport stream port) can also be saved. Reducing the number of pins on the back-end circuit reduces the footprint of the back-end circuit and lowers the cost needed to manufacture the back-end circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital television (DTV) system, comprising:
a front-end circuit;
a back-end circuit;
an external memory coupled to the back-end circuit;
an address bus and a data bus to which the external memory is coupled through a plurality of address and data pins; and
a cryptocard module coupled to the front-end circuit and the back-end circuit for performing conditional access and security functions, the cryptocard module having address and data pins coupled to address and data pins of the external memory.

2. The system of claim 1, further comprising:
a control means for switching the address and data pins of the cryptocard module between
a first mode and a second mode; wherein the back-end circuit comprises a cryptocard module controller generating a control signal coupled to the control means for switching the cryptocard module between the first mode and the second mode.

3. The system of claim 2, wherein the back-end circuit further comprises an input port for receiving data from the cryptocard module when the cryptocard module is in the first mode and for receiving data from the front-end circuit when the cryptocard module is in the second mode.

4. The system of claim 2, wherein the control means comprises at lease a tri-state buffer controlled by the control signal generated by the cryptocard module controller, the control signal switching the tri-state buffers between an enabled state and a high-impedance state for switching the cryptocard module between the first mode and the second mode.

5. The system of claim 2, wherein the control means comprises at least a switch controlled by the control signal generated by the cryptocard module controller for switching the cryptocard module between the first mode and the second mode.

6. The system of claim 2, wherein the control means comprises at least a multiplexer controlled by the control signal generated by the cryptocard module controller for switching the cryptocard module between the first mode and the second mode.

7. The system of claim 2, wherein the back-end circuit further comprises:
an external memory controller;
a pin multiplexer for coupling either the cryptocard module controller or the external memory controller to the address bus and the data bus; and
an arbiter coupled to the cryptocard module controller and the external memory controller, the arbiter receiving requests from the cryptocard module controller and the external memory controller for access to the address bus and the data bus, and granting access by controlling operation of the pin multiplexer.

8. The system of claim 1, wherein the cryptocard module is an Advanced Televisions Systems Committee (ATSC) compliant Point of Deployment (POD)/CableCARD module.

9. The system of claim 1, wherein the cryptocard module is a Digital Video Broadcasting Common Interface (DVB-CI) module.

10. An information receiver, comprising:
a host circuit;
an external memory coupled to the host circuit;
an address bus and a data bus to which the external memory is coupled through a plurality of address and data pins; and
a cryptocard module coupled to the host circuit for performing conditional access and security functions, the cryptocard module having address and data pins coupled to address and data pins of the external memory.

11. The information receiver of claim 10, further comprising:
a control means for switching the address and data pins of the cryptocard module between a first mode and a second mode;
wherein the host circuit comprises a cryptocard module controller generating a control signal coupled to the control means for switching the cryptocard module between the first mode and the second mode.

12. The information receiver of claim 11, wherein the host circuit further comprises:
a digital television (DTV) demodulator; and
an input port for receiving data from the cryptocard module when the cryptocard module is in the first mode and for receiving data from the DTV demodulator when the cryptocard module is in the second mode.

13. The information receiver of claim 11, wherein the control means comprises at least a tri-state buffer controlled by the control signal generated by the cryptocard module controller, the control signal switching the tri-state buffers between an enabled state and a high-impedance state for switching the cryptocard module between the first mode and the second mode.

14. The information receiver of claim 11, wherein the control means comprises at least a switch controlled by the control signal generated by the cryptocard module controller for switching the cryptocard module between the first mode and the second mode.

15. The information receiver of claim 11, wherein the control means comprises a multiplexer controlled by the control signal generated by the cryptocard module controller for switching the cryptocard module between the first mode and the second mode.

16. The information receiver of claim 11, wherein the host circuit further comprises:
an external memory controller;
a pin multiplexer for coupling either the cryptocard module controller or the external memory controller to the address bus and the data bus; and
an arbiter coupled to the cryptocard module controller and the external memory controller, the arbiter receiving requests from the cryptocard module controller and the external memory controller for access to the address bus and the data bus, and granting access by controlling operation of the pin multiplexer.

17. The information receiver of claim 10, wherein the cryptocard module is an Advanced Televisions Systems Committee (ATSC) compliant Point of Deployment (POD)/CableCARD module.

18. The information receiver of claim 10, wherein the cryptocard module is a Digital Video Broadcasting Common Interface (DVB-CI) module.

19. A method for sharing pins between a cryptocard module and external memory in a digital television (DTV) system, the DTV system comprising:
a host circuit comprising:
a cryptocard module controller; and
an external memory controller;
an external memory coupled to the host circuit;
an address bus and a data bus to which the external memory is coupled through a plurality of address and data pins; and
a cryptocard module coupled to the host circuit for performing conditional access and security functions;
the method comprising:
coupling address and data pins of the cryptocard module to address and data pins of the external memory; and
switching the address and data pins of the cryptocard module between a first mode and a second mode.

20. The method of claim 19, further comprising:
coupling the cryptocard module controller and the external memory controller to the address bus and the data bus; and
granting access to the address bus and the data bus to the cryptocard module controller in the first mode or to the external memory controller in the second mode.

21. The method of claim 19, wherein the cryptocard module is an Advanced Televisions Systems Committee (ATSC) compliant Point of Deployment (POD)/CableCARD module.

22. The method of claim 19, wherein the cryptocard module is a Digital Video Broadcasting Common Interface (DVB-CI) module.
